(19) United States
(12) Patent Application Publication
(10) Pub. No.: US 2016/0012460 A1
(43) Pub. Date: Jan. 14, 2016

(54) ENERGY-CONSUMPTION BASED INCENTIVE MANAGEMENT THROUGH SMART METER MONITORING

(71) Applicant: EMPIRE TECHNOLOGY DEVELOPMENT LLC, Wilmington, DE (US)

(72) Inventor: Ezekiel Kruglick, Poway, CA (US)

(73) Assignee: EMPIRE TECHNOLOGY DEVELOPMENT LLC, Wilmington, DE (US)

(21) Appl. No.: 14/769,806

(22) PCT Filed: Apr. 29, 2013
(86) PCT No.: PCT/US13/38691

§ 371 Date: Aug. 22, 2015

(51) Int. Cl. G06Q 30/02; G01D 4/00

(52) U.S. Cl. CPC G06Q 30/0207; G01D 4/002

(57) ABSTRACT

Technologies are generally provided for employing a smart meter to monitor an energy-efficient appliance or upgrade associated with an incentive program and to apply the incentive program to a location associated with the appliance or upgrade. A power utility provider may provide an incentive such as on-bill financing or bill reduction for energy-efficient upgrades, purchases, or otherwise encouraged programs. The utility provider may detect operation of an energy-efficient device such as an appliance at a location through a smart meter and provide the incentive associated with the device to the address where the device is currently operated based on smart meter data. The utility provider may subsequently detect use of the device at a new location based on another smart meter detecting operation of the device at the new location and automatically provide the incentive to the new address upon detection of operation of the device at the new location.

### BACKGROUND

Unless otherwise indicated herein, the materials described in this section are not prior art to the claims in this application and are not admitted to be prior art by inclusion in this section.

Rising power consumption and generation in a consumer environment has created an interest in conserving power and encouraging consumers of utilities to improve their energy efficiency. Reducing energy consumption may reduce short and long term energy costs, conserve energy resources, and reduce environmental impact. Energy and power consumption may be reduced by upgrading older devices and appliances with newer energy-efficient devices, and by making other energy-efficient improvements such as replacing insulation or installing solar panels for generating solar energy.

Utility providers may offer incentive and rebate programs to encourage consumers to make energy-efficient upgrades and improvements. The incentives or rebates are often provided to the consumer on the consumer's monthly utility bill. Some example incentive programs include on-bill financing where the utility provider may pay the initial cost for an energy-efficient upgrade and the consumer may pay back the utility company over an extended term on the monthly utility bill. Other programs may include a reduction on the initial price of an energy-efficient appliance, a monthly bill reduction over a fixed period for the purchase of an energy-efficient appliance, and similar ones. It may be difficult, however, for utility providers to track movable appliances in order to provide rebates or track repayments for on-bill financing. As a result, a utility provider may limit incentive programs to energy-efficient upgrades for permanent home improvements only.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

The present disclosure generally describes methods for providing an energy-consumption based incentive. Example methods may include detecting connection of a device associated with the energy-consumption based incentive to a power grid through a smart meter, providing the energy-consumption based incentive to an address associated with the smart meter, detecting connection of the device to the power grid through another smart meter, and/or providing the energy-consumption based incentive to another address associated with the other smart meter.

The present disclosure also describes a power utility manager for providing an energy-consumption based incentive. An example power utility manager may include one or more of: a communication module configured to communicate with a plurality of smart meters, a processor configured to detect connection of a device associated with the energy-consumption based incentive to a power grid through a first smart meter, provide the energy-consumption based incentive to an address associated with the first smart meter, detect connection of the device to the power grid through a second smart meter, and/or provide the energy-consumption based incentive to another address associated with the second smart meter.

The present disclosure further describes an energy-consumption based incentive manager for managing incentives for a plurality of power utilities. An example incentive manager may include one or more of a communication module configured to communicate with a plurality of smart meters and power utility managers, a processor configured to detect connection of a device associated with the energy-consumption based incentive to a first power grid through a first smart meter, provide the energy-consumption based incentive to an address associated with the first smart meter, detect connection of the device to a second power grid through a second smart meter, provide the energy-consumption based incentive to another address associated with the second smart meter, and coordinate an apportionment of the incentive between the power utility managers of the first power grid and the second power grid.

The present disclosure also describes a computer-readable storage device with instructions stored thereon for providing an energy-consumption based incentive. Example instructions may include one or more of detecting connection of a device associated with the energy-consumption based incentive to a power grid through a smart meter, providing the energy-consumption based incentive to an address associated with the smart meter, detecting connection of the device to the power grid through another smart meter, and providing the energy-consumption based incentive to another address associated with the other smart meter.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates example communications in a home area network (HAN) between a smart meter and an energy management unit (EMU) as well as between the EMU and a solar unit, appliances, and a thermostat;

FIG. 2 illustrates an example smart metering communications infrastructure in a neighborhood area network (NAN);

FIG. 3 illustrates an example schematic for employing a smart meter to monitor consumer devices;

FIG. 4 illustrates an example schematic for employing a smart meter to monitor a consumer appliance and apply an incentive associated with the consumer appliance transported to a new location;

FIG. 5 illustrates an example schematic for applying an incentive for an appliance on a power bill associated with a location employing smart meter power usage records;

FIG. 6 illustrates a general purpose computing device, which may be used to monitor consumer appliances and provide incentives associated with a consumer appliance via a smart meter;

FIG. 7 is a flow diagram illustrating an example method that may be performed by a computing device such as the computing device in FIG. 6; and

FIG. 8 illustrates a block diagram of an example computer program product, all arranged in accordance with at least some embodiments as described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to compositions, methods, apparatus, systems, devices, and/or computer program products related to energy-consumption based incentive management through smart meter monitoring.

Briefly stated, technologies are generally provided for employing a smart meter to monitor an energy-efficient appliance or upgrade associated with an incentive program and to apply the incentive program to a location associated with the appliance or upgrade. A power utility provider may provide an incentive such as on-bill financing or bill reduction for energy-efficient upgrades, purchases, or otherwise encouraged programs. The utility provider may detect operation of an energy-efficient device such as an appliance at a location through a smart meter and provide the incentive associated with the device to the address where the device is currently operated based on smart meter data. The utility provider may subsequently detect use of the device at a new location based on another smart meter detecting operation of the device at the new location and automatically provide the incentive to the new address upon detection of operation of the device at the new location.

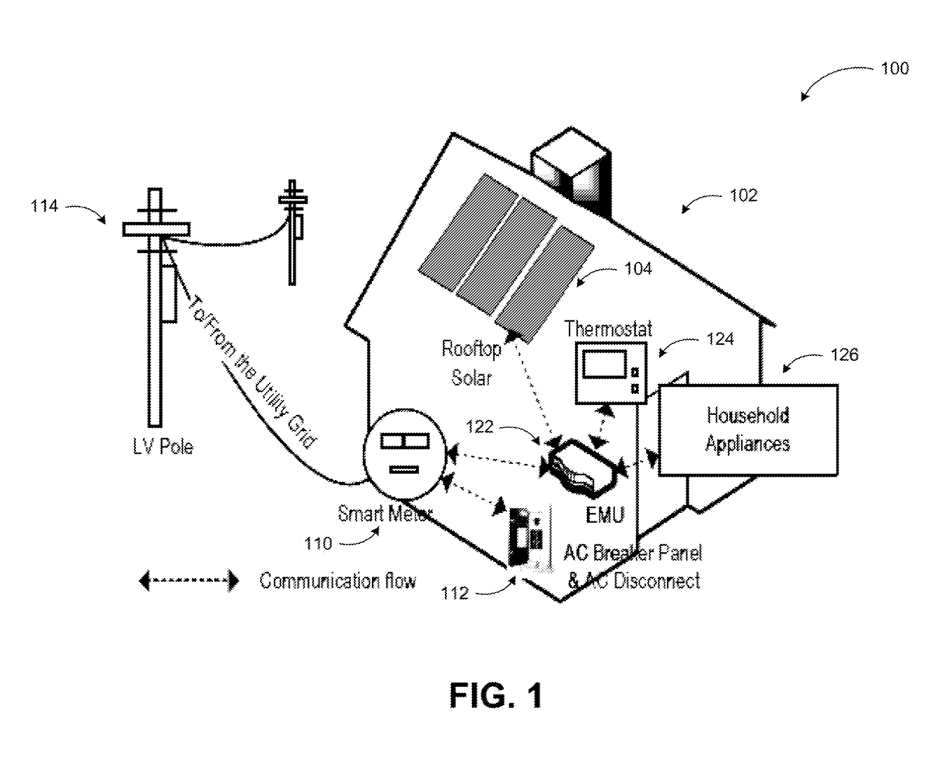

FIG. 1 illustrates example communications in a home area network (HAN) between a smart meter and an energy management unit (EMU) as well as between the EMU and a solar unit, appliances, and a thermostat, arranged in accordance with at least some embodiments as described herein.

Diagram 100 includes a house 102 with photo-voltaic solar array 104, a smart meter 110, and an alternating current (AC) breaker panel and AC disconnect (ACBP&ACD) module 112. Utility pole 114 represents the power grid connecting to the house 102. House 102 in diagram 100 additionally includes EMU 122, thermostat 124, household appliances 126, and other household computing and non-computing devices. As shown in FIG. 1, utility pole 114 representing the power grid is coupled to a smart meter 110, which is coupled to the ACBP&ACD module 112 and EMU 122. The photo-voltaic solar array 104 is also coupled to the EMU 122 along with thermostat 124 and the household appliances.

The photo-voltaic solar array 104 represents an on-location power generation system, which may alternatively be a wind-based power generation system, a bio-mass power generation system, and/or other power generation systems. The photo-voltaic solar array 104 may be operated for power consumption by the household and/or power contribution to the grid. There may be times when power demands of the grid do not justify receiving power generated by the house 102, or when the household power generation system may need to be isolated from the grid. On-location generated power, such as solar power, may be prevented from flowing to the grid by switching off the power line between the ACBP&ACD module 112 and the utility grid at the ACBP&ACD module 112. Actuation of the ACBP&ACD module 112 may allow the house 102 to continuously consume their on-location generated power even though the house 102 is effectively cut off from the grid.

A smart meter as used herein may refer to a monitoring device mainly directed to measuring energy consumption and/or generation at a location (for example, a household), but also capable of communicating with a power utility as well as various smart appliances within the household (or other type of facility). For example, the smart meter may receive changing energy price information (for example, peak time rates vs. off-peak time rates) from the power utility and communicate the changing prices to the smart appliances, some of which may reduce their energy consumption based on that information. A smart meter may also coordinate communications with the power utility related to sale of on-location generated energy (for example, solar) to the power utility. According to some example embodiments, a smart meter may allow the power utility to keep track of an appliance or other device (for example, an electric car or electric car charger) associated with an incentive program such that the incentive program may be applied to the actual address where the appliance or device is currently being used.

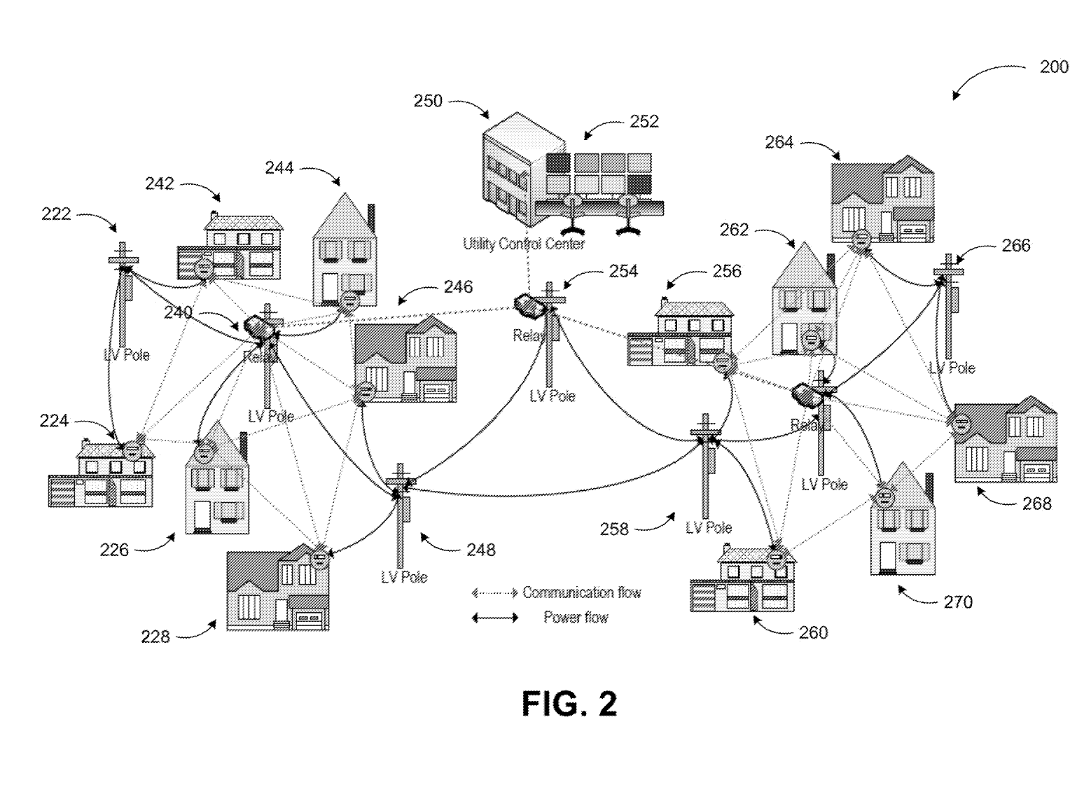

A power network system may monitor and control grid-tied power generation modules associated with consumers through Home Area Networks (HANs) in individual households or facilities and Neighborhood Area Networks (NANs) between smart meters and utility control centers as discussed below in conjunction with FIG. 2. Smart metering communications (SMC) may employ wired or wireless communications based on a proprietary or standard protocol such as IEEE 802.15.4 standard in HAN. The communication protocol may be selected to provide reasonable data rates for small-size data packets with low power transmission while taking into account factors such as RF penetration and less interference.

The HAN may be composed of several components as shown in diagram 100. The smart meter 110 may have multiple built-in functionalities supporting different wired and wireless communications protocols of power line communications and RF technologies, for example. In other examples, a separate communication modem (wired or wireless) may be used to facilitate communications with the utility control center (UCC). The photo-voltaic solar array 104 may have sensors embedded in the inverter for collecting data of the module status (not shown).

The smart meter 110 may be configured to communicate with a plurality of devices within the household, including appliances, wired and wireless computing devices, and other smart and/or non-smart devices. Example smart appliances may be household appliances 126 embedded with sensors and/or intelligent electronic devices to generate power consumption data, which may be communicated to the EMU 122. The thermostat 124 may perform Heating, Ventilating, and Air Conditioning (HVAC) control with communication capability. The EMU 122 may play the role of an intermediate node (for example, a gateway), which may coordinate the household's power consumption via appliances and thermostat, and record solar power generation. The smart meter may further measure and record both solar power generation/surplus and household's power consumption. The smart meter may send signals to one or more switches (for example, ACBP&ACD module 112 in diagram 100) directly or via the EMU 122 when disconnection/reconnection of the household power circuit from/to the grid is decided.

FIG. 2 illustrates an example smart metering communications infrastructure in a neighborhood area network (NAN), arranged in accordance with at least some embodiments as described herein.

Diagram 200 includes households 224, 226, 228, 242, 244, 246, 256, 260, 262, 264, 268, and 270, each with their corresponding smart meters. The households may be connected to a utility control center (UCC) 250 via a grid of power lines. The grid may include poles 222, 240, 254, 258, and 266. Some or all of the poles may include communication relays on them such that communication flow between the smart meters of the individual households and the UCC 250 can be facilitated via the power lines. In other examples, the communication may be facilitated through other networks such as a wireless wide area network, a cellular network, public switched telephone network (PSTN), Digital Subscriber Lines (DSLs), or combinations thereof.

The framework for data exchange between the smart meters and the UCC 250 may be developed using proprietary or standard protocols such as IEEE 802.15.4 and IEEE 802.11. In some example embodiments, the SMC may be constructed as a wireless mesh network. In electric power systems, power flow analysis may be used to schedule and plan for the amount of power flows between buses of the interconnected system. The smart meters may transmit energy profiles of their respective households to the UCC 250 periodically or on-demand depending on the utility operation. The transmission may also be dynamically scheduled based on time of day (for example, more frequently around high-consumption times and less frequently around low-consumption times). The UCC 250 may send signal packets to specific smart meters to communicate with the smart meters.

Smart grid communications may involve large amounts of data transmission and exchanges between the utility control center and smart meters to allow two-way communication between the utility control center and the smart meters. The smart meters may communicate with devices and appliances in the households to manage power consumption by transmitting smart messages to the appliances and devices.

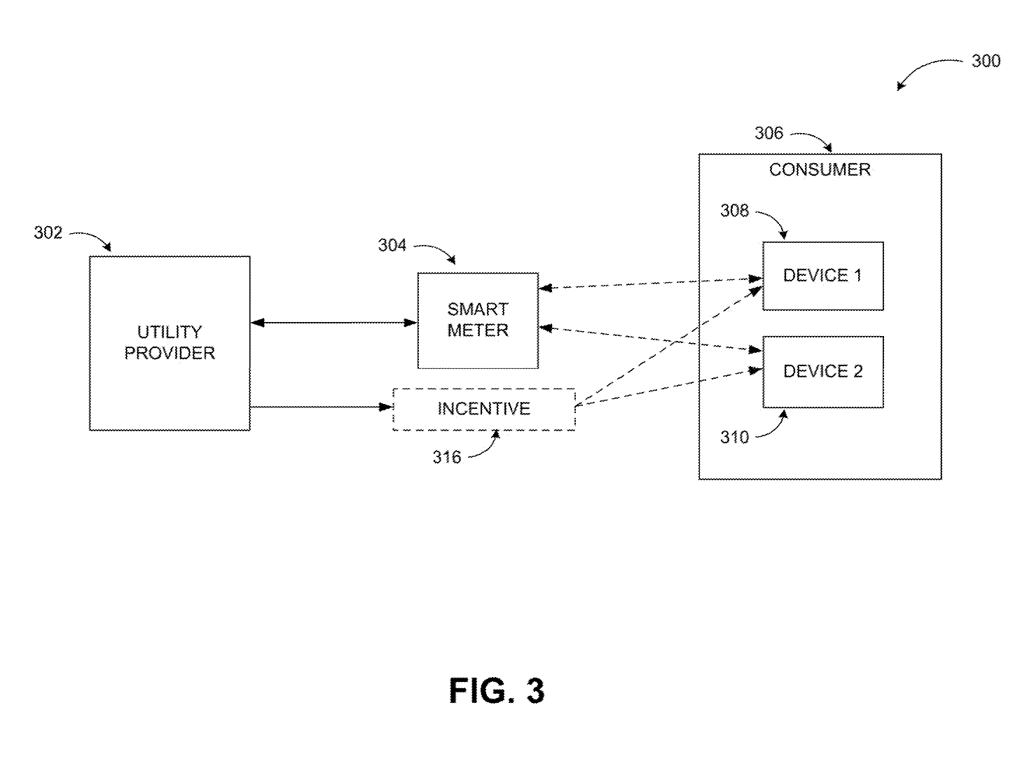

FIG. 3 illustrates an example schematic for employing a smart meter to monitor consumer devices, arranged in accordance with at least some embodiments as described herein.

As previously discussed, there may be a strong interest in encouraging consumers of energy to improve energy consumption and to improve the efficiency of their appliances and similar devices. Energy consumption may refer to an amount of energy that is spent on various devices and appliances at a location, and improving energy consumption may include reducing an amount of energy consumed and may also include preserving and storing energy in a distributed manner for later release. For example, energy and power consumption may be used in encouraging environment-friendly initiatives such as use of electric cars, which may store energy in a distributed manner and release it for the power grid. Reducing energy consumption may reduce short and long term energy costs, conserve energy resources, and reduce emissions. Consumers may reduce energy consumption in their households and businesses by upgrading devices and appliances with newer energy-efficient models. For example a consumer may replace appliances such as refrigerators, freezers, HVAC systems, ovens, stoves, dishwashers, and clothes washers and dryers with energy-efficient versions which may use substantially less energy than older appliances or adjust their energy consumption to reduce a load on the power grid at peak consumption times. Additionally, consumers may make other energy improvements such as replacing insulation and installing solar panels for generating solar power in order to reduce their energy consumption, as some examples. Reducing energy consumption may result in a financial cost saving to consumers over time if the energy savings offsets any additional costs of implementing an energy-consumption improving technology. However, an initial cost of replacing old appliances with energy-efficient appliances and making other energy upgrades may be relatively expensive, and as a result some consumers may be deterred from making energy upgrades because of the expense.

An “incentive” as used herein may refer to a variety of programs used by utilities to encourage consumers to reduce their energy consumption through efficiency improvements and to encourage improved energy systems. For example, an incentive may also refer to a program used by utilities to encourage the use of energy storage devices such as an electric car which may be used to provide energy storage in a distributed manner for a power grid. Incentive do not need to encourage less energy consuming devices, but they may encourage the use of smart devices that can manage their consumption based on time of day, season of year, etc. such that a burden on the power grid is reduced. Other example incentives may include, but are not limited to, up-front price reductions, periodic utility bill reductions, periodic repayment of up-front financing, and similar ones.

A power utility provider 302 may provide an incentive 316 to encourage a consumer 306 to upgrade older devices and appliances 308, 310 to energy-efficient appliances for long term energy conservation interests. An example incentive 316 may be a periodically applied rebate, which may be a financial incentive for the consumer 306 to upgrade to energy-efficient appliances. The rebate may help to offset a portion of the out of pocket cost for the consumer 306 to pay for the upgrade. For example, the power utility provider 302 may offer a cash rebate to the consumer to replace an inefficient appliance 310, such as a water heating system, with a newer energy-efficient water heating system in order to offset some of the up-front cost of purchasing and installing the new water heating system. The cash rebate may be issued as a credit on the consumer's utility bill at a location where the associated appliance 310 is operated over a predefined period (for example, each month for a year).

Another example incentive 316 may include an on-bill financing option which may give the consumer 306 an opportunity to finance energy-efficient improvements and upgrades to their households and businesses with little or no up-front costs. For example, the consumer 306 may replace an old appliance 308, such as a refrigerator, with a newer energy-efficient model. The power utility provider 302 may finance the up-front cost of the installation, and the consumer 306 may pay back the power utility provider 302 over an extended term on the monthly utility bill at a reduced interest rate. Since the newer energy-efficient appliance may conserve energy and cost less to operate, the monthly energy savings may offset the payment for replacing the system. For example, the power utility provider 302 may set the monthly payback payment to be equal to the amount of energy costs saved in operating the new appliance. Once the cost of the energy-efficient upgrade has been paid off, the consumer 306 may see a decrease in the monthly utility bills reflective of the energy efficiency upgrades.

In a system according to embodiments, the power utility provider 302 may use a smart meter 304 installed at a location associated with the consumer 306, such as a household or workplace, in order to track devices 308, 310 at the consumer's household or workplace to provide on utility bills associated with a particular device. A device may include energy efficient and/or smart consumer appliances such as washing machines, dishwashers, HVAC systems, swimming pool pumps, and other devices such as electric cars, electric car chargers, and solar panels as some examples. The smart meter 304 may be configured to identify a plurality of devices at a location and to detect an energy consumption of each device. The power utility provider 302 may use the energy consumption data for each device detected by the smart meter 304 in order to apply the incentive to a specific device operated at the location.

As previously described, a smart meter 304 may have multiple built-in functionalities supporting different wired and wireless communications to allow the smart meter 304 to communicate with a plurality of wired and wireless enabled devices, such as devices located within a household or other location. The smart meter 304 may identify smart devices and/or appliances, that is, devices configured to communicate with other devices over a wired or wireless connection, by exchanging signals and messages with the devices. The smart meter 304 may also be configured to identify non-smart devices and/or appliances, that is, devices not configured to communicate with other devices, by detecting a power consumption of a particular device and comparing the detected power consumption with a database of devices and power consumptions to identify a list of potential devices associated with the smart meter 304 at the location.

As discussed previously, devices whose use may be incentivized may include energy-efficient devices, energy-smart devices (that can regulate timing and amount of energy used based on power grid conditions), and/or devices that can assist energy distribution through storage and release (e.g., electric cars).

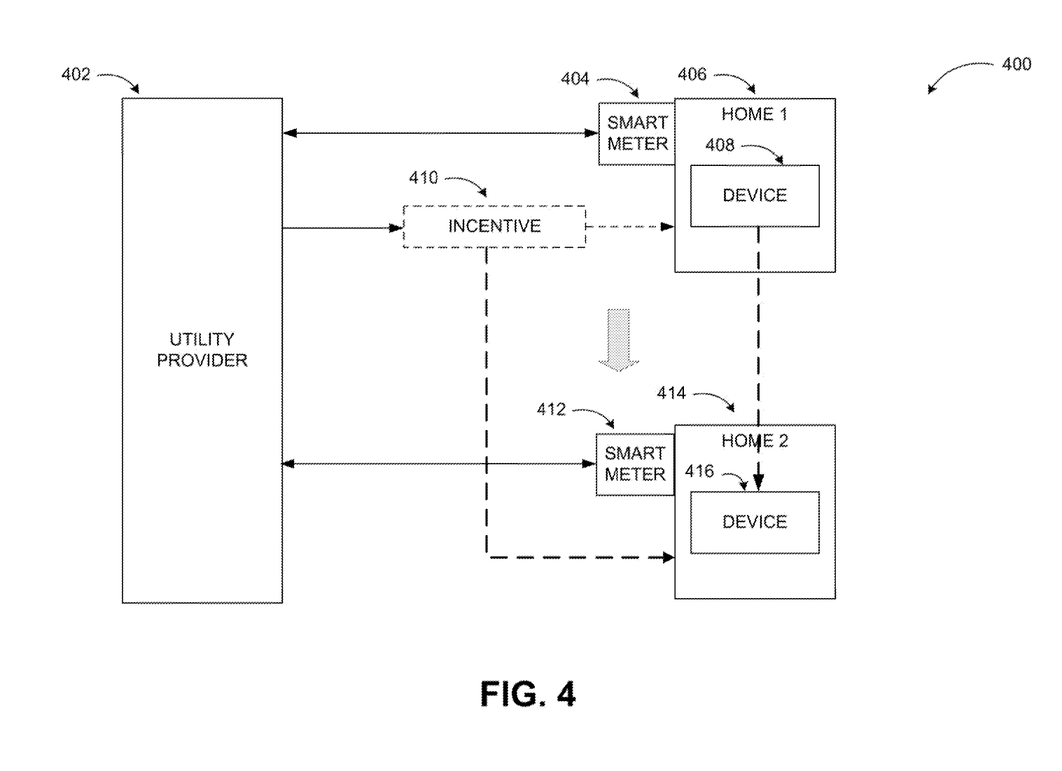

FIG. 4 illustrates an example schematic for employing a smart meter to monitor a consumer device and apply an incentive associated with the consumer device transported to a new location, arranged in accordance with at least some embodiments as described herein.

As previously discussed in conjunction with FIG. 3, a power utility provider 402 may use smart meters 404 and 412 installed at a location associated with a consumer, such as a household or workplace, in order to track devices 408, 416 at the consumer's household or workplace to provide on utility bills associated with a particular device. The smart meter 404 may be configured to identify a plurality of devices at a location and to detect an energy consumption of each device. The power utility provider 402 may use the energy consumption data for each device detected by the smart meter 404 in order to apply an incentive to a specific device operated at the location.

While some devices such as a heating and cooling system or insulation improvement may be permanent home improvements, other devices such as a washing machine, refrigerator, dishwasher, pool pump, and electric car charger, to name a few, may be portable, and may be moved to new houses or sold to a different consumer. Using a smart meter network, the power utility provider 402 may be able to track when a portable device is transported to a new location to ensure that an incentive 410 associated with a particular device is applied to a utility bill at a location where the device associated with the incentive is located. Tracking the portable devices may also prevent a consumer from taking advantage of an incentive to upgrade a device at a reduced price, and selling the device to another consumer who does not get the benefit of the incentive, or, in another scenario, moving the device to a new location and leaving a new homeowner to pay for the device on the utility bills.

For example, a consumer may upgrade to an energy-efficient device 408 at their home 406, and may receive an incentive 410 associated with the device 408 on their utility bill at the home 406. Subsequently the consumer may move to a new house, home 414 and take the upgraded device 408 with them. In order to avoid having a new homeowner at the home 406 to pay the utility bill for the upgraded device that the last owner took with him, the power utility provider 402 may track the device when it is transported to the new home 414 employing a smart meter network and redirect the incentive to the new home 414.

As previously described, a smart meter 404 may be associated with a particular address, such as a household or workplace, which may be connected with a power grid. The smart meter 404 may be coupled with the power grid, and may be configured to detect a plurality of devices and devices operating at the address and connected to the power grid. The smart meter 404 may also be configured to detect an energy consumption of each detected device, and may provide the detected energy consumption for each detected device to the power utility provider 402. The power utility provider 402 may track the location of a particular device based on a known address of the smart meter detecting the energy consumption.

In another example scenario, an environmentally friendly electric car may allow its owner to receive a monthly reduction in electricity bill because it allows the power grid to take advantage of the car's energy-storing capability by charging the car at one location and time and allowing it to release the stored energy at another location or time. However, the owner may share the car with a friend of relative, and the car may be plugged in at two different locations. Thus, using a smart meter based monitoring system according to embodiments the power utility provider 402 may apportion the electricity bill reduction between the two locations encouraging both drivers of the car to take advantage of the incentive program. Similarly, an employer may allow its employees to charge their electric cars at their work place. Again, using a smart meter based monitoring system, the power utility provider may reward the employer by giving a portion of the incentive to the employer based on a time each car spends charging at the work place or an amount of power consumed by each car charging at the work place, thereby extending the encouraging effect beyond just the owners of the devices/cars.

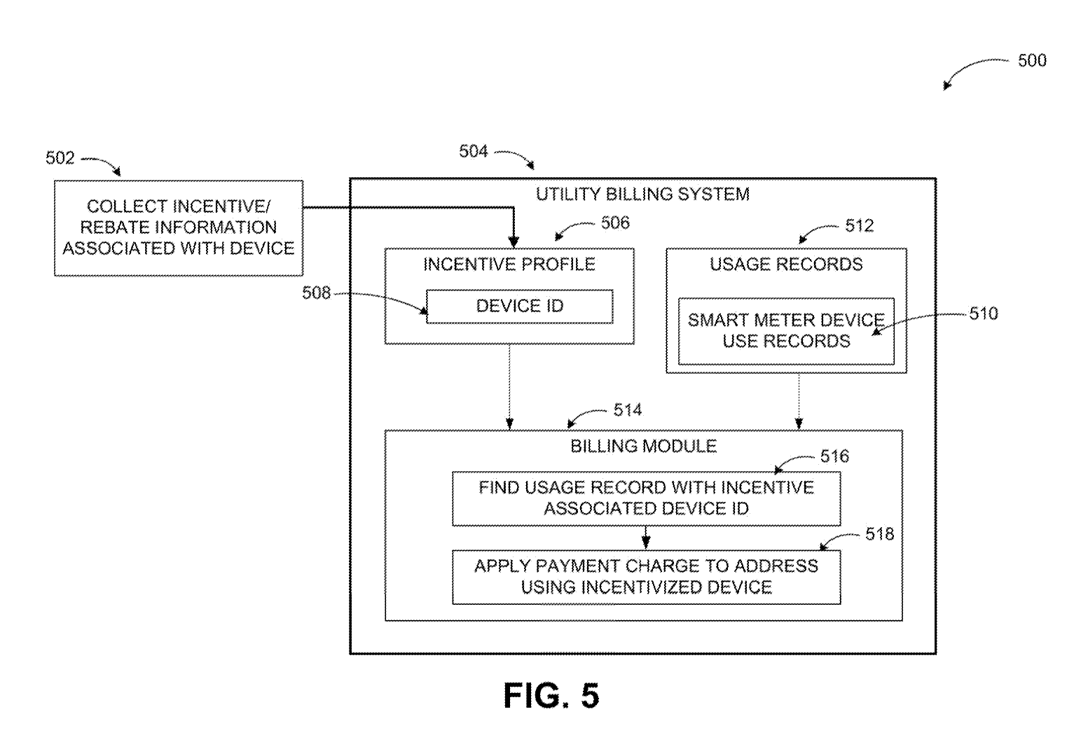

FIG. 5 illustrates an example schematic for applying an incentive for a device on a power bill associated with a location employing smart meter power usage records, arranged in accordance with at least some embodiments as described herein.

A power utility provider may use energy records detected through a smart meter network in order to provide incentives associated with particular devices to a location where the devices are operated. In a system according to embodiments, a consumer may take advantage of a financial incentive program offered by the power utility provider to upgrade to an energy-efficient device. An example energy-efficient device may include one or more of a monitoring device, an electronic device, a device, a portable air conditioner, an electric car, a solar power generation device, or a car charging device, as some examples. The example devices listed above are not intended to be limiting, but are intended to be exemplary of some devices that may be replaced with energy-efficient models.

In an example scenario, when the consumer upgrades to a new device, the consumer may inform the power utility provider of the upgrade, and the power utility may collect (502) information associated with the device such as a serial number or other identification information associated with the new device. The power utility provider may create an incentive profile 506 for the registered device. The incentive profile 506 may be stored in a data store associated with a utility billing system 504 associated with the power utility provider configured to manage incentives. The incentive profile 506 may include the device identification 508 as well as information on the type of incentive that may be associated with the registered device.

A billing module 514 operated by the utility billing system 504 may be configured to compare the incentive profile 506 for the registered device to smart meter usage records database 512 which may contain energy information about the registered device, including an address of a location where the registered device is operated. As previously described, a smart meter network may include a plurality of smart meters operating at locations such as households and workplaces, for example, configured to detect devices operating at each location associated with a smart meter. In an example embodiment, when a smart meter detects a device at a location, the smart meter may identify the device and create an energy consumption record for the detected device, which may be stored in the smart meter usage records database 512. The smart meter usage records database 512 may include addresses where each smart meter in the smart meter network is located, and may include identification information for devices and devices operating at the address where each smart meter is located.

In order to provide the incentive to the consumer, the billing module 514 may locate (516) a usage record for the device identification 508 in the smart meter usage records database 512 to confirm an address where the device is being operated. The billing module 514 may apply the incentive to a monthly utility bill associated with the address where the registered device is located. This may allow a consumer using an on-bill financing type incentive to finance an energy-efficient upgrade and then move to a new location, and on-bill financing payments may automatically follow to the new location without requiring the consumer to actively register or inform the power utility of the move. Additionally, if a registered device is not found in any usage records for some period for time, the incentive may be declare defaulted and the original consumer may be billed for delinquent payments, for example.

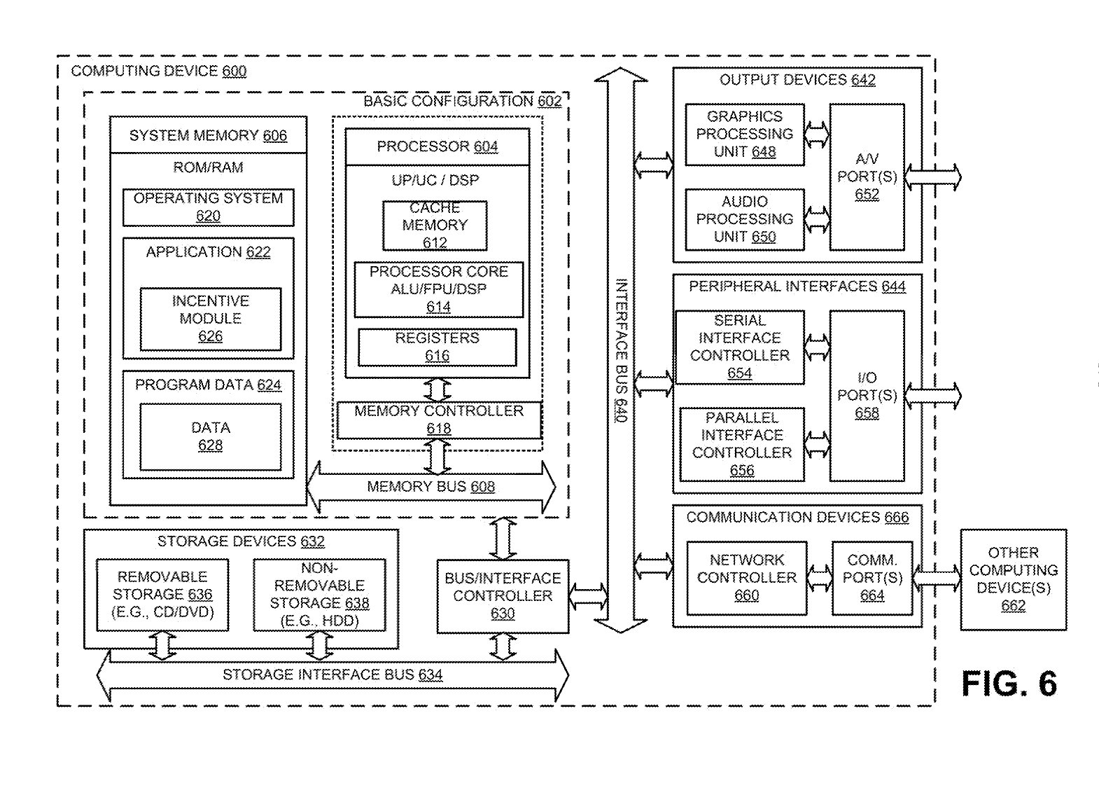

FIG. 6 illustrates a general purpose computing device, which may be used to monitor consumer devices and provide incentives associated with a consumer device via a smart meter, arranged in accordance with at least some embodiments as described herein.

For example, the computing device 600 may be used as a server, desktop computer, portable computer, smart phone, special purpose computer, or similar device such as the smart meter 110 or the EMU 122 of FIG. 1. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, one or more applications 622, and program data 624. The application 622 may include an incentive module 626, which may be an integral part of the application 622 or a separate application on its own. The incentive module 626 may facilitate receiving identification information for registering an energy-consumption improving device to receive an incentive, detect operation of the device at a location, and coordinate applying the incentive to a utility bill associated with the location where the device is operated, as described herein. The program data 624 may include, among other data, data 628 related to device identification and location information detected by a smart meter of devices associated with an incentive, or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller, which may be arranged to facilitate communications with one or more other computing devices over a network communication link via one or more communication ports 654. The one or more other computing devices may include servers, client devices, smart appliances, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

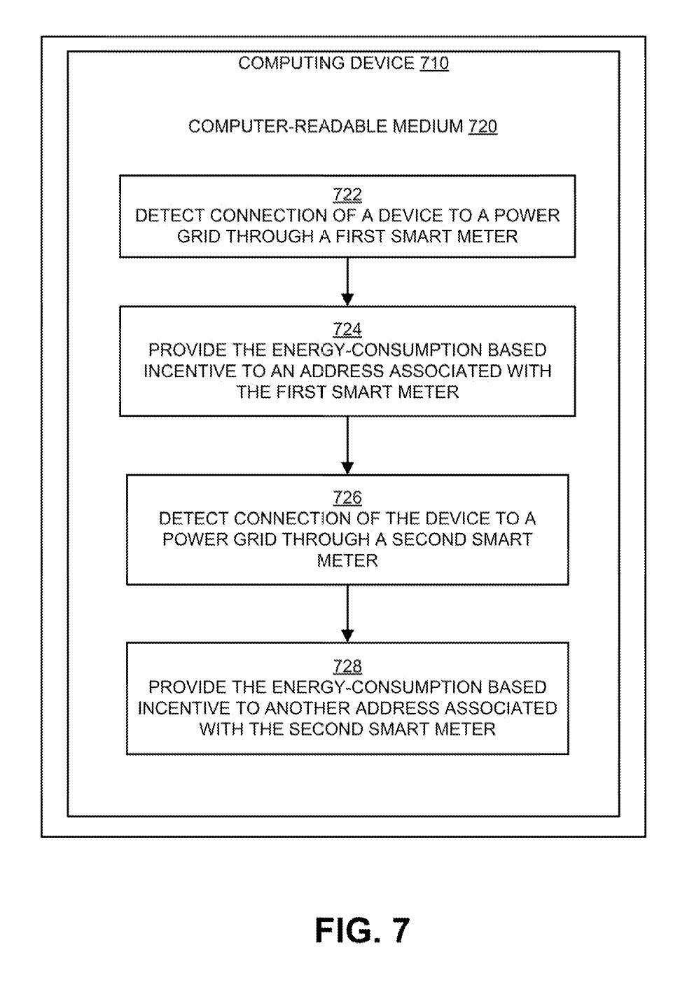

FIG. 7 is a flow diagram illustrating an example method that may be performed by a computing device such as the computing device in FIG. 6, arranged in accordance with at least some embodiments as described herein.

Example methods may include one or more operations, functions or actions as illustrated by one or more of blocks 722, 724, 726, and 728. The operations described in the blocks 722 through 728 may also be stored as computer-executable instructions in a computer-readable medium such as a computer-readable medium 720 of a computing device 710.

An example process for employing a smart meter to monitor a consumer appliance and apply an incentive associated with the consumer appliance may begin with block 722, “DETECT CONNECTION OF A DEVICE TO A POWER GRID THROUGH A FIRST SMART METER,” where a power utility company may detect a device associated with an energy-consumption based incentive at a location. An example device may be an appliance such as a refrigerator, a portable air conditioner, washer and dryer, solar panels, or an electric car charger. The device may be connected at a location such as a household or business to a power grid associated with the location. The power utility company may detect the device at the location employing a smart meter at the location configured to detect the device and an energy consumption of the device. An example smart meter may be smart meter 110 of FIG. 1 configured to allow two-way communication with a plurality of devices at the household.

Block 722 may be followed by block 724, “PROVIDE THE ENERGY CONSUMPTION BASED INCENTIVE TO AN ADDRESS ASSOCIATED WITH THE FIRST SMART METER,” where the power utility company may provide an incentive associated with the device to an address associated with the smart meter. An example incentive may be a rebate provided on a monthly utility bill or an up-front financing with monthly pay-back for the address associated with where the device associated with the incentive is located.

Block 724 may be followed by block 726, “DETECT CONNECTION OF THE DEVICE TO A POWER GRID THOUGH A SECOND SMART METER,” where the power utility company may detect the device at a new address through detection of the device by a second smart meter associated with the new address.

Block 726 may be followed by block 728, “PROVIDE THE ENERGY CONSUMPTION BASED INCENTIVE TO ANOTHER ADDRESS ASSOCIATED WITH THE SECOND SMART METER,” where power utility company may provide the incentive associated with the device to the new address associated with the second smart meter where the device is currently operated.

The blocks included in the above described process are for illustration purposes. Employing a smart meter to monitor a consumer device and apply an incentive associated with the consumer device may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

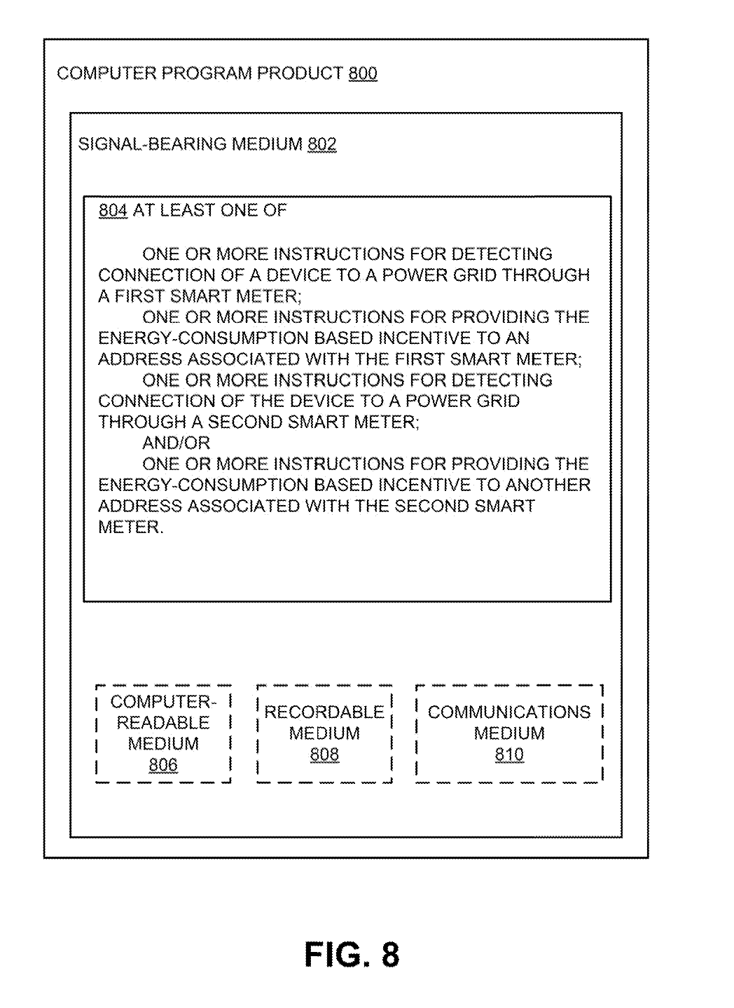

FIG. 8 illustrates a block diagram of an example computer program product, arranged in accordance with at least some embodiments as described herein.

In some embodiments, as shown in FIG. 8, the computer program product 800 may include a signal bearing medium 802 that may also include one or more machine readable instructions 804 that, when executed by, for example, a processor may provide the functionality described herein. Thus, for example, referring to the processor 604 in FIG. 6, an incentive module 626 executed on the processor 604 may undertake one or more of the tasks shown in FIG. 8 in response to the instructions 804 conveyed to the processor 604 by the medium 602 to perform actions associated with employing a smart meter to monitor a consumer appliance and apply an incentive associated with the consumer appliance as described herein. Some of those instructions may include, for example, instructions for employing a smart meter to monitor a consumer appliance and apply an incentive associated with the consumer appliance may include, detecting connection of a device to a power grid through a first smart meter, providing the energy consumption based incentive to an address associated with the first smart meter, detecting connection of the device to a power grid though a second smart meter, and providing the energy consumption based incentive to another address associated with the second smart meter, according to some embodiments described herein.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (for example, a fiber optic cable, a waveguide, a wired communications link, a wireless communication link, etc.). Thus, for example, the program product 800 may be conveyed to one or more modules of the processor 604 of FIG. 6 by an RF signal bearing medium, where the signal bearing medium 802 is conveyed by the wireless communications medium 810 (for example, a wireless communications medium conforming with the IEEE 802.11 standard).

According to some examples, the present disclosure describes a method for providing an energy-consumption based incentive. The method may include detecting connection of a device associated with the energy-consumption based incentive to a power grid through a smart meter, providing the energy-consumption based incentive to an address associated with the smart meter, detecting connection of the device to the power grid through another smart meter, and providing the energy-consumption based incentive to another address associated with the other smart meter.

According to some examples, detecting connection of the device to the power grid may include determining a device identifier through the smart meter, updating an incentive profile associated with the device, and tracking an energy consumption of the device while the device may be connected to the power grid through the smart meter. The method may also include determining the device identifier through one of a wireless and a wired communication between the device and the smart meter.

According to some examples, the method may also include recording the energy consumption of the device, and updating the incentive profile based on the recorded energy consumption. The incentive may be provided on a utility bill for the address associated with the smart meter. The method may also include switching the incentive to a utility bill for the other address associated with the other smart meter upon detecting the connection of the device to the power grid through the other smart meter.

According to some examples, the method may also include confirming an actual location of the device at the address associated with the smart meter if the connection of the device to the power grid through the smart meter may be detected through wireless communication between the smart meter and the device.

According to other examples, the method may also include apportioning the incentive based on one or more of: a length of time spent at a location of the device and on an energy consumption of the device through the respective smart meters upon detecting connection of the device to the power grid through two or more smart meters during a predefined period. The device may include at least one of: a monitoring device, an electronic device, an appliance, a heating/ventilation/air conditioning (HVAC) device, an electric car, a solar power generation device, or a car charging device. The device may be portable.

According to other examples, the present disclosure describes a power utility manager for providing an energy-consumption based incentive. The power utility manager may include a communication module configured to communicate with a plurality of smart meters, and a processor. The processor may be configured to detect connection of a device associated with the energy-consumption based incentive to a power grid through a first smart meter, provide the energy-consumption based incentive to an address associated with the first smart meter, detect connection of the device to the power grid through a second smart meter, and provide the energy-consumption based incentive to another address associated with the second smart meter.

According to some examples, the processor may be further configured to determine a device identifier associated with the device through the first smart meter, update an incentive profile associated with the device based on the device identifier, and track an energy consumption of the device while the device may be connected to the power grid through the first smart meter.

According to further examples, the processor may be further configured to determine the device identifier through one of a wireless and a wired communication between the device and the first smart meter. The processor may be further configured to record the energy consumption of the device, and update the incentive profile based on the recorded energy consumption.

According to further examples, the processor may be further configured to provide the incentive on a utility bill for the addresses associated with the first smart meter and the second smart meter. The processor may be further configured to automatically switch the incentive to a utility bill for the other address associated with the second smart meter upon detecting the connection of the device to the power grid through the second smart meter.

According to yet other examples, the processor may be further configured to request confirmation of an actual location of the device at the address associated with the first smart meter if the connection of the device to the power grid through the first smart meter may be detected through wireless communication between the first smart meter and the device. The processor may be further configured to apportion the incentive based on one or more of: a length of time spent at a location of the device and an energy consumption of the device through the respective smart meters upon detecting connection of the device to the power grid through two or more smart meters during a predefined period. The processor may be further configured maintain an energy consumption records database for a plurality of devices.

According to further examples, the present disclosure also describes an energy-consumption based incentive manager for managing incentives for a plurality of power utilities. The incentive manager may include a communication module configured to communicate with a plurality of smart meters and power utility managers, and a processor configured to detect connection of a device associated with the energy-consumption based incentive to a first power grid through a first smart meter, provide the energy-consumption based incentive to an address associated with the first smart meter, detect connection of the device to a second power grid through a second smart meter, provide the energy-consumption based incentive to another address associated with the second smart meter, and coordinate an apportionment of the incentive between the power utility managers of the first power grid and the second power grid.

According to some examples, the processor may be further configured to determine a device identifier associated with the device through the first smart meter, update an incentive profile associated with the device based on the device identifier, and track an energy consumption of the device while the device may be connected to the first power grid through the first smart meter and the second power grid through the second smart meter. The processor may be further configured to determine the device identifier through one of a wireless and a wired communication between the device and the first smart meter or the second smart meter.

According to other examples, the processor may be further configured to record the energy consumption of the device, and update the incentive profile based on the recorded energy consumption. The processor may be further configured to provide the incentive on utility bills for the addresses associated with the first smart meter and the second smart meter. The processor may be further configured to switch the incentive to a utility bill for the other address associated with the second smart meter upon detecting the connection of the device to the second power grid through the second smart meter.

According to other examples, the processor may be further configured to request confirmation of an actual location of the device at the address associated with the smart meter if the connection of the device to a power grid through a smart meter may be detected through wireless communication between the smart meter and the device. The first power grid and the second power grid may be managed by the same power utility manager. The processor may be further configured to maintain an energy consumption records database for a plurality of devices.

According to yet other examples, the present disclosure also describes a computer-readable storage device with instructions stored thereon for providing an energy-consumption based incentive. The instructions may include detecting connection of a device associated with the energy-consumption based incentive to a power grid through a smart meter, providing the energy-consumption based incentive to an address associated with the smart meter, detecting connection of the device to the power grid through another smart meter, and providing the energy-consumption based incentive to another address associated with the other smart meter.

According to some examples, detecting connection of the device to the power grid may include determining a device identifier through the smart meter, updating an incentive profile associated with the device, and tracking an energy consumption of the device while the device may be connected to the power grid through the smart meter. The instructions may further include determining the device identifier through one of a wireless and a wired communication between the device and the smart meter. The instructions may also include recording the energy consumption of the device, and updating the incentive profile based on the recorded energy consumption. The incentive may be provided on a utility bill for the address associated with the smart meter.

According to some examples, the instructions may further include switching the incentive to a utility bill for the other address associated with the other smart meter upon detecting the connection of the device to the power grid through the other smart meter. The instructions may also include confirming an actual location of the device at the address associated with the smart meter if the connection of the device to the power grid through the smart meter may be detected through wireless communication between the smart meter and the device.

According to some examples, the instructions may further include apportioning the incentive based on one or more of: a length of time spent at a location of the device and an energy consumption of the device through the respective smart meters upon detecting connection of the device to the power grid through two or more smart meters during a predefined period. The device may include at least one of: a monitoring device, an electronic device, an appliance, a heating/ventilation/air conditioning (HVAC) device, an electric car, a solar power generation device, or a car charging device. The device may be portable.

### Example 1

### Solar Power Rebate

Solar photovoltaic (PV) technology can produce all or a portion of a home's energy needs during daylight hours. A utility company may provide a rebate offering a financial incentive to residential customers who install PV systems by offsetting some of the upfront costs. The utility company may offer a rebate of up to $5,000, where participants may be reimbursed a rate per watt based on the amount of direct or diffused sunlight available related to the PV system's location. When a consumer installs the PV system, the consumer may notify the utility company, and the utility company may consult a smart meter usage records database to identify a smart meter operating at the consumer's location to determine if the PV system has been installed and if it is being operated. Upon detection of the PV system, the utility company may issue the rebate as a credit on the consumer's utility bill in an appropriate amount based upon the rebate terms. If the consumer moves the PV system to a different location, the utility company may detect the move through the smart meter at the new location and move the rebate to the address of the new location automatically without burdening the consumer with the effort and paperwork associated with notifying the utility company, ensuring the change is made correctly, etc.

### Example 2

### On-Bill Financing to Offset Upgrade Cost

A consumer may replace an old clothing washer and dryer with a new, energy-efficient washer and dryer, and may finance the up-front costs of purchasing and installing the new washer and dryer with a utility company. The financing may be paid back to the utility company through a $10 add-on in the monthly utility bills until the financed amount is repaid. The new clothing washer and dryer may provide savings of about $10 a month in energy consumption making the net effect to the consumer zero until the financed amount is paid and a reduction of about $10 afterwards. However, the consumer may move after six months taking the washer and dryer with him. Since the utility bill is associated with the address, the new home owner may be stuck with the financing add-on of the previous home owner. Using the smart meter based monitoring system, however, the utility company may detect the installation of the washer and dryer at a new location and automatically change the financing add-on to the utility bill of the new location (for the consumer who financed the appliances). Thus, the new homeowner may avoid having to deal with the financing of the previous homeowner and the previous homeowner may enjoy the savings in the utility bill of his new home after dutifully paying the financed amount.

### Example 3

### Tracking an Electric Car at Different Charging Locations

Because electric cars cost considerably more than regular combustion-engine cars, two environmentally-conscious consumers may decide to buy and share a zero-emission electric car. The utility company, as part of the state's environment initiative, may encourage use of electric cars by providing a 5% reduction in electricity bill for the portion of electricity used to charge the car. The utility company may incentivize electric cars also because they may be used to provide energy storage in a distributed manner for the power grid. Smart meters at the homes of the consumers may detect the car being charged at each home during different days and times of day, as well as the amount of electricity consumed at each location. By recording this information in the incentive profiles of both consumers, the utility company may reduce the electricity bills of the consumers in proportion to the amounts of energy used in charging the car, thereby rewarding both consumers for their environment-friendly effort.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (for example, feedback for sensing position and/or velocity of gantry systems; control motors for moving and/or adjusting components and/or quantities).

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various compositions, methods, systems, and devices are described in terms of “comprising” various components or steps (interpreted as meaning “including, but not limited to”), the compositions, methods, systems, and devices can also “consist essentially of” or “consist of” the various components and steps, and such terminology should be interpreted as defining essentially closed-member groups.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to provide an energy-consumption based incentive, the method comprising:
detecting, through a smart meter, connection of a device associated with the energy-consumption based incentive to a power grid, wherein the connection of the device to the power grid is at a first location;
determining a first portion of the energy-consumption based incentive by apportioning the energy-consumption based incentive based on a length of time spent by the device at the first location while the device is connected to the power grid;
providing the first portion of the energy-consumption based incentive to an address associated with the first location;
detecting, through another smart meter, another connection of the device to the power grid, wherein the another connection of the device to the power grid is at a second location;
determining a second portion of the energy-consumption based incentive by apportioning the energy-consumption based incentive based on another length of time spent by the device at the second location while the device is connected to the power grid; and
providing the second portion of the energy-consumption based incentive to another address associated with the second location.

2. The method according to claim 1, wherein detecting, through the smart meter, the connection of the device associated with the energy-consumption based incentive to the power grid comprises:
receiving a device identifier from the smart meter;
updating an incentive profile associated with the device based on the device identifier; and
tracking, through the smart meter, an energy consumption of the device while the device is connected to the power grid at the first location.

3. The method according to claim 2, wherein receiving the device identifier includes:
determining the device identifier through one of a wireless and a wired communication between the device and the smart meter.

4. The method according to claim 2, further comprising:
recording the energy consumption of the device; and
wherein updating the incentive profile includes updating the incentive profile based on the recorded energy consumption.

5. The method according to claim 1, wherein providing the first portion of the energy-consumption based incentive to the address associated with the first location includes providing the incentive on a utility bill for the address associated with the first location.

6. The method according to claim 5, further comprising:
switching the incentive to a utility bill for the another address associated with the second location in response to detection, through the another smart meter, of the connection of the device to the power grid at the second location.

7. The method according to claim 1, further comprising:
confirming an actual location of the device in response to detection of the connection of the device to the power grid through wireless communication between the smart meter and the device.

8. (canceled)

9. The method according to claim 1, wherein the device includes at least one of: a monitor device, an electronic device, an appliance, a heating/ventilation/air conditioning (HVAC) device, an electric car, a solar power generation device, or a car charger device.

10. (canceled)

11. A power utility manager to provide an energy-consumption based incentive, the power utility manager comprising:
a communication module configured to communicate with a plurality of smart meters;
a processor coupled to the communication module and configured to:
detect, from a first communication between the communication module and a first smart meter, connection of a device associated with the energy-consumption based incentive to a power grid, wherein the connection of the device to the power grid is at a first location;
determine a first portion of the energy-consumption based incentive by apportionment of the energy-consumption based incentive based on a length of time spent by the device at the first location while the device is connected to the power grid;
provide the first portion of the energy-consumption based incentive to a first address associated with the first location;
detect, from a second communication between the communication module and a second smart meter, another connection of the device to the power grid, wherein the another connection of the device to the power grid is at a second location;
determine a second portion of the energy-consumption based incentive by apportionment of the energy-consumption based incentive based on another length of time spent by the device at the second location while the device is connected to the power grid; and
provide the second portion of the energy-consumption based incentive to a second address associated with the second location.

12. The power utility manager of claim 11, wherein the processor is further configured to:
receive a device identifier associated with the device from the first smart meter;
update an incentive profile associated with the device based on the device identifier, and
track, through the first smart meter, an energy consumption of the device while the device is connected to the power grid at the first location.

13. (canceled)

14. The power utility manager of claim 12, wherein the processor is further configured to:
record the energy consumption of the device; and
wherein to update the incentive profile, the processor is configured to update the incentive profile based on the recorded energy consumption.

15. The power utility manager of claim 11, wherein to provide the first and second portions of the energy-consumption based incentive respectively to the first and second addresses, the processor is configured to:
provide the first and second portions of the energy-consumption based incentive on a utility bill for the first and second addresses respectively associated with the first smart meter and the second smart meter.

16. (canceled)

17. The power utility manager of claim 11, wherein the processor is further configured to:
request confirmation of an actual location of the device at the first address associated with the first smart meter in response to detection of the connection of the device to the power grid through wireless communication between the first smart meter and the device.

18. (canceled)

19. The power utility manager of claim 11, wherein the processor is further configured to:
maintain an energy consumption records database for a plurality of devices.

20. An energy-consumption based incentive manager to manage incentives for a plurality of power utilities, the incentive manager comprising:
a communication module configured to communicate with a plurality of smart meters and power utility managers;
a processor coupled to the communication module and configured to:
detect, from a first communication between the communication module and a first smart meter, a first connection of a device associated with the energy-consumption based incentive to a first power grid, wherein the first connection of the device to the first power grid is at a first location;
determine a first portion of the energy-consumption based incentive by apportionment of the energy-consumption based incentive based on a length of time spent by the device at the first location while the device is connected to the first power grid;
provide the energy-consumption based incentive to a first address associated with the first location;
detect, from a second communication between the communication module and a second smart meter, a second connection of the device to a second power grid, wherein the second connection of the device to the second power grid is at a second location;
provide the second portion of the energy-consumption based incentive to a second address associated with the second location; and
coordinate an apportionment of the energy-consumption based incentive between the power utility managers of the first power grid and the second power grid.

21. The incentive manager of claim 20, wherein the processor is further configured to:
receive a device identifier associated with the device from the first smart meter and the second smart meter;
update an incentive profile associated with the device based on the device identifier, and
track, through the first smart meter and the second smart meter, an energy consumption of the device while the device is connected to the first power grid at the first location and the second power grid at the second location.

22. (canceled)

23. The incentive manager of claim 21, wherein the processor is further configured to:
record the energy consumption of the device; and
wherein to update the incentive profile, the processor is configured to update the incentive profile based on the recorded energy consumption.

24. The incentive manager of claim 20, wherein the processor is further configured to:
provide the incentive on utility bills for the first and second addresses respectively associated with the first and second locations.

25. The incentive manager of claim 24, wherein the processor is further configured to:
switch the incentive to a utility bill for the second address associated with the second location in response to detection, through the second smart meter, of the second connection of the device to the second power grid at the second location.

26. The incentive manager of claim 20, wherein the processor is further configured to:
request confirmation of an actual location of the device at the first address associated with the first location in response to detection of the first connection of the device to the first power grid through wireless communication between the first smart meter and the device.

27. The incentive manager of claim 20, wherein the first power grid and the second power grid are managed by a same power utility manager.

28.-38. (canceled)
